(19) United States
(12) Patent Application Publication
(10) Pub. No.: US 2011/0108362 A1
(43) Pub. Date: May 12, 2011

(54) Free energy

(76) Inventor: Daniel Paul Gorney, Toledo, OH (US)

(21) Appl. No.: 12/590,770

(22) Filed: Nov. 12, 2009

(51) Int. Cl. F03G 3/00; F03G 7/10

(52) U.S. Cl. 185/27; 74/DIG. 9

(57) ABSTRACT

Free Energy is a perpetual motion machine that operates indefinitely and independently without any other source of fuel, electricity, or any other renewable energy source other than gravity. Free Energy produces more energy than the amount of energy necessary to operate the machine itself. Never before has a machine of this nature been produced. Free Energy utilizes magnetism, water pressure, buoyancy, gravity, leverage, and the physical properties of Helium to operate.

Free Energy is a machine that operates indefinitely without any other source of fuel, electricity, or any other renewable energy source other than gravity.

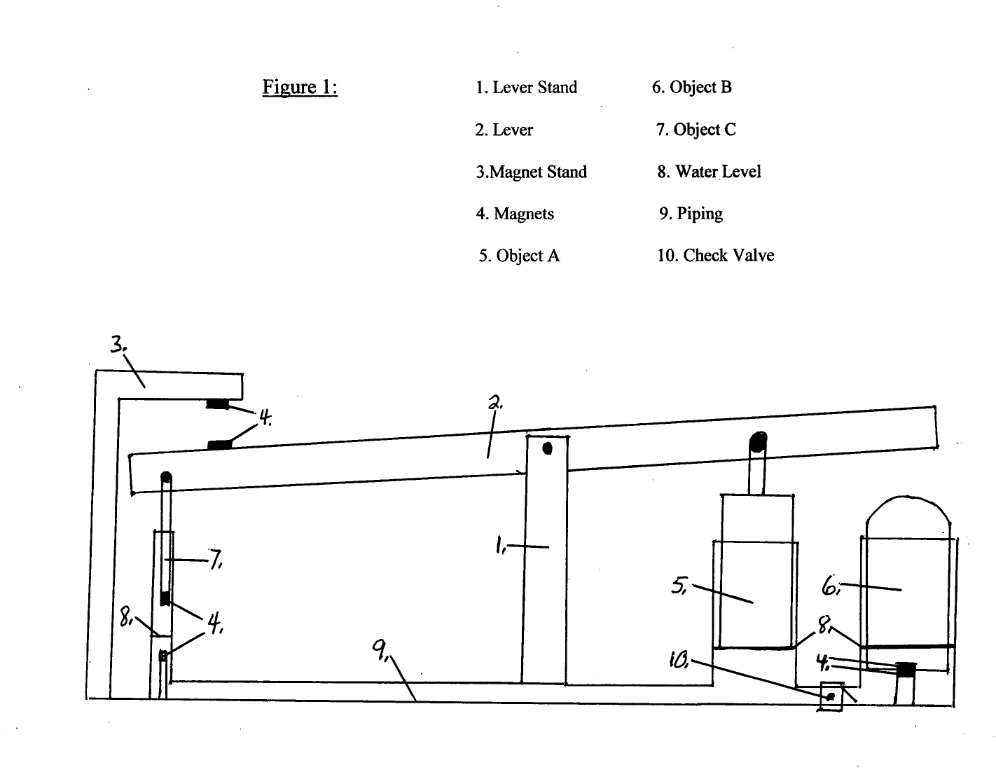

Starting Position: (See FIG. 1) The right side of the lever is slightly heavier than the left side of the lever to ensure movement. As the left side of the lever rises, the force of the attracting magnets attached to the left side of the lever and the magnet stand increases simultaneously with the increasing force of the water that is being displaced by Object A. These forces are equal throughout the motion of the lever when the left side of the lever is moving upwards. As the left side of the lever is in the full upward position, the right side of the lever is still slightly heavier than the left side of the lever. Thus, a relatively small amount of force greater than the difference between the right and left sides of the lever will push the lever back the opposite direction.

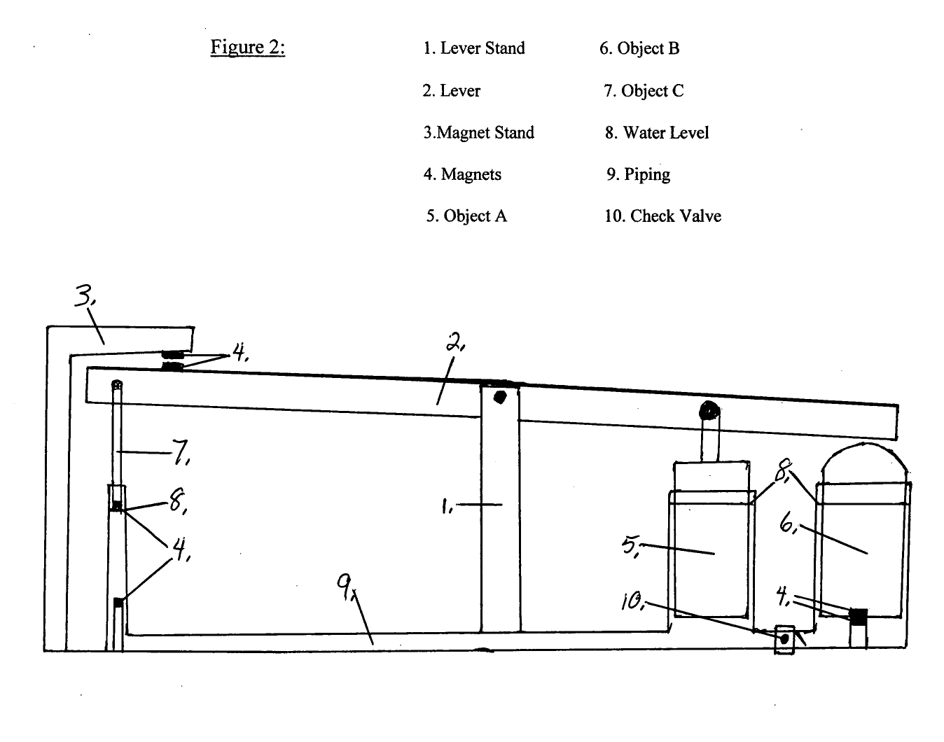

(see FIG. 2) As the water is displaced, pressure is also increasing on Object B. Object B is filled with Helium, is nearly weightless, and is larger than Object A, thus creating more buoyant force than Object A. This can easily be accomplished since some of the water being displaced by Object A can be used to go around Object B. Object B is held down by two attracting magnets, one fixed to Object B, and the other fixed to a permanent fixture in the system.

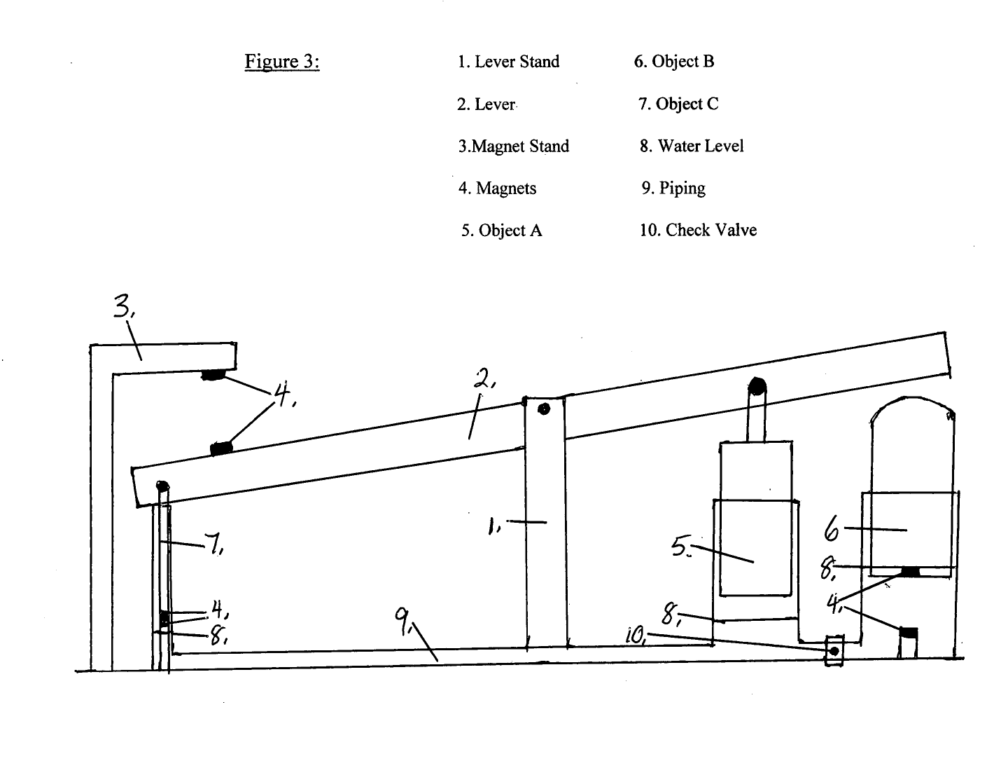

(see FIG. 3) As the water pressure on Object B surpasses the magnetic force holding down Object B, Object B moves upwards pushing the right side of the lever upwards with greater force than the amount of force produced by Object A. Also, Object B is further from the fulcrum point than Object A, so less force is needed, using leverage, to put the left side of the lever back down. Since Object B is further from the fulcrum point than Object A, Object B must move upward further than Object A. This can be accomplished by calculating the volume of water around Objects A and B. A greater amount of water is around Object B than Object A. When Object B moves upward, the water does not decrease in height as much as the water around Object A does, when Object A moves upward.

A check valve in the system prevents the water from rapidly leaving the area around Object B. Object B pushes the lever back in the opposite direction with greater force than the force of the attracting magnets on the left side of the lever and the magnet stand.

Hanging downward on the left side of the lever is Object C. Object C has a small, weak magnet on the bottom of it, which is attracted to another fixed magnet inside the left side of the system. The magnetic force at this point is greater than the difference of the weight between the right and left side of the lever. The two magnets fully connect and temporarily hold the lever.

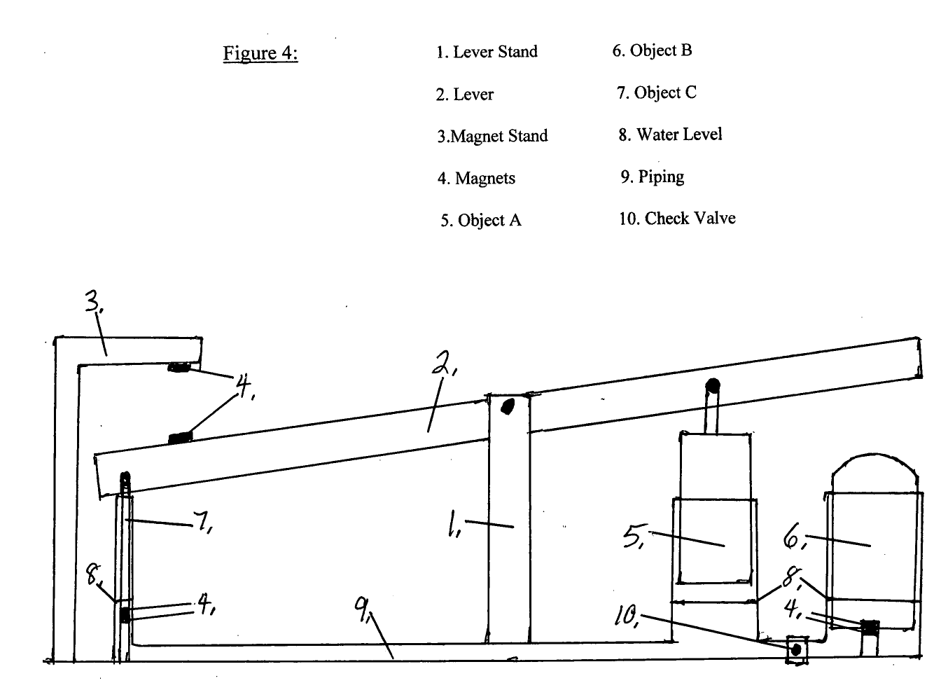

(see FIG. 4) There is a small hole in the check valve door, much smaller than the check valve door itself. The hole is just big enough to allow water to slowly go through it.

As the water is reaching equilibrium, the water is rising around Object C. Object C is buoyant. The magnets release when the buoyant force of Object C is greater than the magnetic force holding the lever.

As the water is draining from the area around Object B, Object B is lowered to a point where the magnetic force of the magnets under Object B is greater than the water pressure around Object B. The magnets reconnect and hold Object B down until the water pressure around Object B is greater than the magnetic force holding Object B down.

(see FIG. 1) The right side of the lever is heavier than the left side of the lever and the process repeats. Free Energy.

1. Free Energy is a machine that operates indefinitely and produces more energy than the amount of energy necessary to operate the machine itself without any other source of fuel, electricity, or any other renewable energy source other than gravity.
